(19) United States
(12) Patent Application Publication
(10) Pub. No.: US 2008/0129599 A1
(43) Pub. Date: Jun. 5, 2008

(54) Systems and methods for locating targets using digital elevation model survey points

(76) Inventors: Steven H. Thomas, Brooklyn Center, MN (US); Larry D. Almsted, Bloomington, MN (US)

Correspondence Address: HONEYWELL INTERNATIONAL INC., 101 COLUMBIA ROAD, P O BOX 2245, MORRISTOWN, NJ, 07962-2245, US

(21) Appl. No.: 11/294,865

(22) Filed: Dec. 5, 2005

Related U.S. Application Data
(60) Provisional application No. 60/708,577, filed on Aug. 16, 2005.

(51) Int. Cl. G01S 3/02

(52) U.S. Cl. 342/458; 342/357.17

(57) ABSTRACT

A method for determining the position of a target using digital terrain elevation data survey points and a corresponding target locating system are described. The method includes selecting at least two surveyed reference points from the digital terrain elevation data, determining a location of the target locator with respect to the digital terrain elevation data, and referencing the location of the target to the digital terrain elevation data. The method further includes measuring a position of the target locator, and translating a difference between the determined location and the measured position of the target locator to the referenced location of the target.

### CROSS REFERENCE TO RELATED APPLICATIONS

This application claims priority to U.S. Provisional Application Ser. No. 60/708,577, filed Aug. 16, 2005, which is hereby incorporated by reference in its entirety.

### BACKGROUND OF THE INVENTION

This invention relates generally to target locators, and more specifically, to methods and systems for locating targets using digital elevation model survey points.

A target locator is typically used to remotely locate a target by measuring a range and a direction (e.g., azimuth and elevation angles) to the target. The location of the target, for example, in coordinates, is then computed based on the GPS coordinates of the position of the target locator and the range and direction. The target location is then utilized by a command and control center to guide surveillance or a weapon system to the computed location of the target.

In one known system, the target location process utilizes gyro-compassing techniques coupled with a laser range finder to obtain an absolute direction and range to the target. However, this target locator system is only suitable for large explosive weapon systems because there are some inaccuracies in the range and direction measurements. These inaccuracies result in a circular error probability (CEP) of approximately 80 meters. For lower cost and smaller explosive weapon systems, the existing target locator system does not provide the necessary target location accuracies. For these smaller explosive weapons systems, a CEP of about five meters at ranges of about five kilometers is desired.

The existing system using absolute target measurement techniques along with the gyro-compassing mechanization is not capable of meeting these higher accuracy requirements. Therefore, a different target locator mechanization is needed to meet the higher accuracies desired.

### BRIEF SUMMARY OF THE INVENTION

In one aspect, a method for determining a position of a target using digital terrain elevation data survey points is provided. The method comprises selecting at least two surveyed reference points from the digital terrain elevation data, and determining a location of the target locator with respect to the digital terrain elevation data. The method also comprises referencing the location of the target to the digital terrain elevation data, measuring a position of the target locator, and translating a difference between the determined location and the measured position of the target locator to the referenced location of the target.

In another aspect, a target location system is provided that comprises a digital terrain elevation data and a system processor comprising a user interface. The digital terrain elevation data comprises a plurality of surveyed points and is communicatively coupled to the system processor. The system processor is configured to allow a user to select at least two of the surveyed points as reference points, and further programmed to determine a location of the target location system and a target with respect to the digital terrain elevation data based on the selected reference points.

In still another aspect, a processor for determining a position of a target is provided. The processor forms a portion of a target locating system and is programmed to receive data relating to at least two surveyed reference points from a digital terrain elevation data, receive data relating to a global position of the target locating system, receive data relating to an angle to the surveyed reference points and the target with respect to a magnetic field, and receive data relating to a range to the target and a range to each surveyed reference point. The processor determines a location of the target locating system and with respect to the digital terrain elevation data utilizing the data relating to the range and angle to each surveyed reference point, and determines a position of the target utilizing the data relating to the range and angle to each surveyed reference point and a translation of the location of the target locating system to the received position of the target locating system.

### BRIEF DESCRIPTION OF THE DRAWINGS

FIG. 1 is an operational diagram illustrating target location using relative sensing.

FIG. 2 is an operational diagram illustrating target location using relative sensing techniques including mapped reference points.

FIG. 3 is a block diagram of a target locator system that includes a capability of using mapped survey points in target location.

### DETAILED DESCRIPTION OF THE INVENTION

By using relative sensing with respect to a fixed reference or surveyed point and a more accurate azimuth and elevation sensor mechanization, the accuracy of a target locator can be improved as much as a factor of ten and can provide position accuracies of five meters at ranges of five kilometers. Such accuracies allows low cost, small, explosive weapon systems to be used effectively against targets.

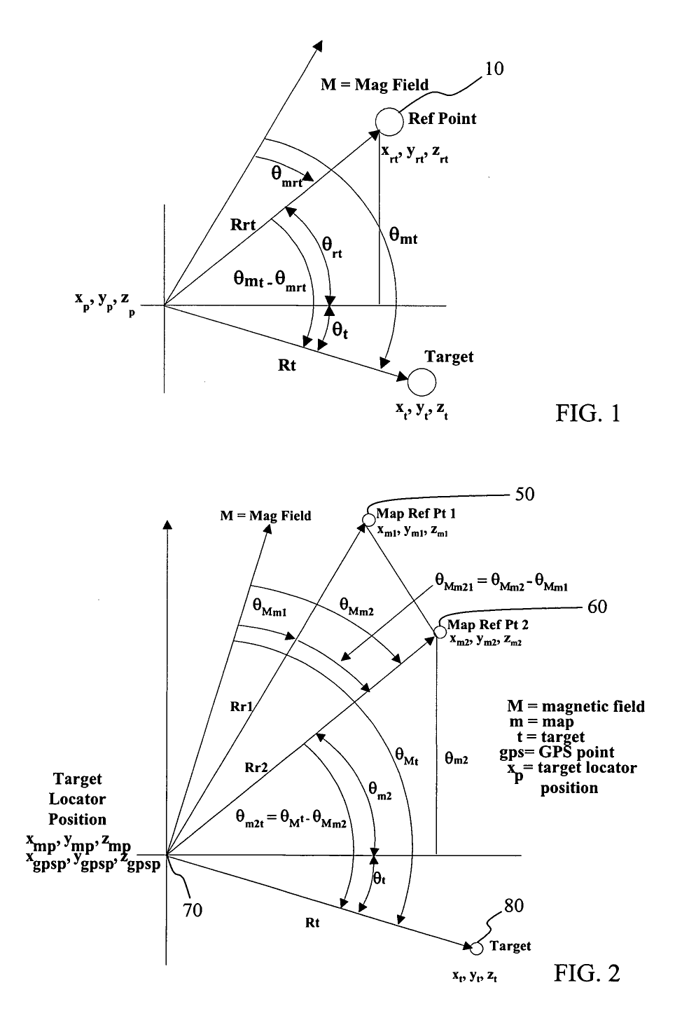

Relative sensing is accomplished by establishing a reference survey point that is located in less-hostile areas. FIG. 1 is an operational diagram illustrating relative sensing. A reference point position (xᵣₜ, yᵣₜ, zᵣₜ) 10 is measured in one embodiment utilizing GPS. Also, a surveyed point (xₚ, yₚ, zₚ) 20 is measured using the GPS. Surveyed point 20 is where a target locator is positioned.

In one embodiment incorporating relative sensing, it is assumed that either the same GPS receiver or another GPS receiver with similar error characteristics is used and the measurement time between the two surveyed points (xₚ, yₚ, zₚ and xᵣₜ, yᵣₜ, zᵣₜ) is small, that is, satellite positions are similar. As a result, the errors at both these locations are related and therefore, most of the GPS errors are canceled which results in relative position of the reference target and the measurement location being very accurate.

Assuming positions xₚ, yₚ, zₚ and xᵣₜ, yᵣₜ, zᵣₜ are accurately “surveyed” using GPS, then the exact range, Rᵣₜ, between these two points is computed to establish range truth. Using a laser rangefinder, range, Rᵣₜ, is measured and compared against a range truth. A laser rangefinder bias error is determined and used as an offset when an actual target range, Rₜ, is measured. As a result, the target range can be measured very accurately to within one-half meter.

For making azimuth and elevation measurements, in one embodiment, rather than a magnetic compass sensor, a non-contact, high resolution anisotropic magneto-resistive (AMR) sensor is utilized to measure angular position. One particular AMR sensor is capable of measuring the angle direction of a magnetic field from a self-contained magnet with less than 0.05° resolution.

The advantages of measuring field direction versus field strength (i.e. like a magnetic compass) include: insensitivity to the temperature coefficient of the magnet, less sensitivity to shock and vibration, and the ability to withstand large variations in the gap between the sensor and magnet. Such magnets are typically located on a stationary tripod section and the AMR sensor is aligned and then rotated with the optical sites and the laser rangefinder.

The field strength from the magnet at the sensor is 100 times the strength of the earth field and as a result, is more stable and less susceptible to perturbations from outside environments. Magnetic field direction is not critical since relative angular positions rather than absolute positions are being measured. As a result, there is minimal calibration of the AMR sensor mechanization in the field. Output is from a Wheatstone bridge that permits balanced output signals for noise immunity. A low offset amplifier and high resolution delta-sigma converter (i.e. analog to digital converter) is utilized to meet a desired accuracy of ±0.05°.

In one operational scenario, a sight reticle is moved to align with the reference target. The angle between the magnetic field and the reference target is then measured (θₘᵣₜ). The sight reticle is then moved to the target and the angle between the magnetic field and the target is measured (θₘₜ). Subtracting one angle from the other results in an angle between the reference target and the actual target (θₘₜ−θₘᵣₜ). The angle θᵣₜ is calculated knowing the reference target position, and as a result, the target azimuth angle (θₜ) can be determined.

While the above described relative sensing method provides a great deal of accuracy, one of the problems associated with such a method is that a survey reference point has to be measured utilizing the GPS. Such a survey reference point can be several thousand meters away from the target locator position. This distance can result in time consuming measurements and also may put the person making the GPS measurements in danger while operating in a hostile environment, which is obviously undesirable.

The below described system and methods eliminate the need for a person to measure a survey reference point utilizing GPS while still providing a high resolution target location function and still incorporating a relative sensing mechanization.

Specifically, FIG. 2 illustrates target location utilizing digital elevation model survey points. For example, a stored map with surveyed points of object or terrain dominant features is stored in the target locator and provided for display to the operator. From the survey map, a first reference point 50 and a second reference point 60 are selected by an operator. Using the two map survey (reference) points 50 and 60, the position of target locator 70 is measured with respect to the map (e.g., map survey points 50 and 60). In one embodiment, a range from the target locator to the two map survey (reference) points 50 and 60 is measured utilizing a laser range finder. The ranges are Rr1 and Rr2 respectively.

Still referring to FIG. 2, θ_{Mm21} is measured using an azimuth sensing mechanization, specifically: θ_{Mm21}=θ_{Mm2}−θ_{Mm1}. Using θ_{Mm21} and the ranges Rr1 and Rr2, the position of target locator is calculated (e.g., xₘₚ, yₘₚ, zₘₚ). More specifically, the map reference points relating to the position of the target locator (xₘₚ, yₘₚ, zₘₚ) are determined knowing Rr1, Rr2, the angle between them (θ_{Mmr21}), and map reference points xₘ₁, yₘ₁, zₘ₁ and xₘ₂, yₘ₂, zₘ₂.

To determine a location of the target 80, the target location is measured with reference to the map. First, the target range, Rt, is measured using the laser range finder, and azimuth angle to the target 80 is measured by measuring θ_{Mt} and θ_{Mm2} and then determining θₘ₂ₜ according to θₘ₂ₜ=θ_{Mt}−θ_{Mm2}. Since points xₘ₂, yₘ₂, zₘ₂ and xₘₚ, yₘₚ, zₘₚ, are known θₘ₂ can be determined which allows for θₜ to be determined according to θₜ=θₘ₂ₜ−θₘ₂.

To measure the elevation angle of the target, the elevation sensor mechanization is utilized, for example, the orthogonal accelerometers in an inertial measurement sensor that senses gravity force vectors.

Target locator position is then measured using GPS. The difference between the GPS target locator position and the target locator position with respect to the map is then utilized to determine a translation correction from the map coordinate system to GPS coordinates. The target position is then translated into GPS coordinates using the translation correction. The result is that the target location is provided in either map coordinates or GPS coordinates. The weapon system is typically in GPS coordinates. Having both the target location and the weapon system in the same coordinate system provides relative positioning and therefore, minimizes target location errors (TLE).

The above described target location method utilizes accurate survey points from a survey map of dominant features. In at least one embodiment, survey points are measured by generating digital elevation models (DEMs) using high resolution preprocessed level IV or level V digital terrain elevation data (DTED) and corresponding maps with appropriate registration.

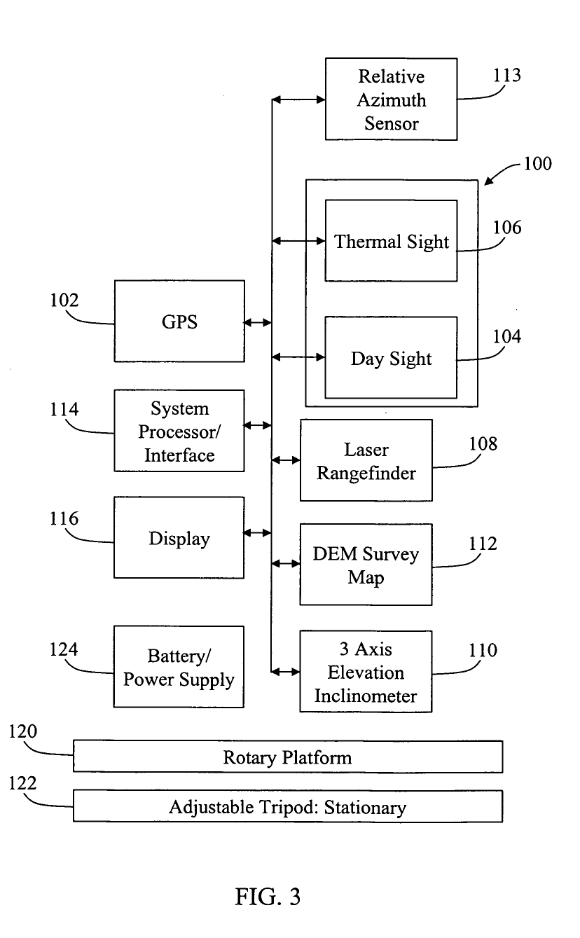

FIG. 3 is a block diagram of a target locator system 100 configured to locate targets using digital elevation model survey points. GPS 102 provides a position of target locator system 100 (e.g., x_{gpsp}, y_{gpsp}, and z_{gpsp}). The sights, specifically, a day operation sight 104 or a night operation (i.e. thermal) sight 106, each contain a reticle that is used to accurately align laser rangefinder 108 and inclinometer 110 to the target. A range to each of the target and the map reference points are determined using laser rangefinder 108. System 100 further includes digital elevation model (DEM) survey points 112 and a relative azimuth sensor 113 that provides the azimuth sensing mechanization described above. For example, DEM survey points 112 includes a stored map with surveyed points of object or terrain dominant features which may be provided for display to an operator of system 100. The above described components of system 10 are controlled by and provide data to system/processor interface 114 which provides data to display 116 where it can be viewed by an operator of system 100.

In one embodiment, system 100 includes a rotary platform 120 on which the above described components are mounted, and rotary platform 120 is attached to a stationary, adjustable tripod 122. All components of system 100 that utilize power are supplied that power from battery/power supply 124.

System 100 further includes several new technologies which enable such a target position solution. For example, a large capacity memory storage capability in smaller package sizes is available. In one embodiment, within a single small module (DEM survey map 112), more than 64 gigabytes can be stored, which allows for a large quantity of map survey point data to be included within. In addition, loss-less compression techniques enable even higher densities of data. With high resolution Level V digital terrain elevation data (DTED), more than 100,000 square miles can be stored on a small board housing 64 gigabytes of memory and using a 8× loss-less compression algorithm.

DTED is Department of Defense standard terrain model generated by NGA (National Geospatial Agency). Accurate precision strike needs prompted a requirement for higher resolution elevation data. For example, Level III (i.e. 10 meter accuracy) and Level IV (3 meter accuracy) DETD has been measured using optical and interferometric synthetic aperture radar (IFSAR) from air vehicles and satellites.

High resolution digital point position data base (DPPDB) from NGA is a set of controlled stereo images with support data covering nominally a one-degree rectangle (3600 nmi²). DPPDB provides for accurate three dimensional (3D) object measurement (i.e. Level V or 1 meter accurate elevation data) of cultural and object/terrain features for weapon system mission planning.

This high resolution DPPBD is typically used for navigation of weapon or aircraft systems such as a precision terrain aided navigation (PTAN) system. PTAN is an autonomous navigation aide that measures terrain features, correlates those terrain features to stored digital terrain elevation data (DTED) and provides precision air vehicle position. Since reference points for target location are stationary, this simplifies the application of geo-location survey maps using DPPBDs. Speed or time are not a major issues for this application. However, precision is still required to survey and map dominant object or terrain features so that high precision target location is achieved.

As described above, map resolution and accuracy of DTED data has been improved with the aid of optical and interferometric synthetic aperture radar. As such, digital maps can provide significantly better accuracy than GPS surveyed points, and digital map technology continues to improve. The above described methods and systems are capable of being integrated into next generation weapon systems. This integration provides a unique solution for determining a target position that allows relative sensing target location without having a person to travel to a reference point and take a GPS reference reading.

While the invention has been described in terms of various specific embodiments, those skilled in the art will recognize that the invention can be practiced with modification within the spirit and scope of the claims.

1. A method for determining a position of a target using digital terrain elevation data survey points, said method comprising the steps of:
selecting at least two surveyed reference points from the digital terrain elevation data, wherein a resolution of the digital terrain elevation data is associated with a first level of accuracy;
determining a location of a target locator with respect to the digital terrain elevation data;
referencing the location of the target to the digital terrain elevation data;
measuring a position of the target locator using a positioning system wherein a resolution of the position measurement is associated with a second level of accuracy and the first level of accuracy is substantially higher than the second level of accuracy; and
translating a difference between the first level of accuracy of the determined location and the second level of accuracy of the measured position of the target locator to the referenced location of the target.

2. A method according to claim 1 wherein determining a location of the target locator comprises:
measuring a range to the surveyed reference points;
measuring an angle between the two reference points referenced to the target locator position; and
calculating map reference points for the target locator using the measured angle and ranges.

3. A method according to claim 2 wherein measuring a range to the surveyed reference points comprises measuring the range to the surveyed reference points with a laser rangefinder.

4. A method according to claim 2 wherein measuring an angle between the two reference points comprises:
measuring an angle of each surveyed reference point with respect to a magnetic field and a position of the target locator; and
determining the angle between the surveyed reference points with respect to the target locator.

5. A method according to claim 4 wherein measuring an angle of each surveyed reference point comprises determining the angles utilizing an azimuth sensing mechanization.

6. A method according to claim 1 wherein referencing the location of the target to the digital terrain elevation data comprises:
measuring a range to the target;
measuring an azimuth angle to the target with respect to a magnetic field; and
measuring an elevation angle of the target.

7. A method according to claim 6 wherein measuring an azimuth angle to the target comprises:
measuring an angle of the target with respect to a magnetic field and a position of the target locator;
measuring an angle of one surveyed reference point with respect to a magnetic field and a position of the target locator; and
determining the angle between the surveyed reference point and the target with respect to the target locator.

8. A method according to claim 1 further comprising translating a position of the target from digital terrain elevation data coordinates to GPS coordinates.

9. A target location system comprising:
a system processor comprising a user interface;
a positioning system coupled to the system processor, said system processor configured to receive a position measurement of said target location system from said positioning system, wherein a resolution of said position measurement is associated with a first level of accuracy; and
digital terrain elevation data comprising a plurality of surveyed points, wherein a resolution of the digital terrain elevation data is associated with a second level of accuracy, and the second level of accuracy is substantially higher than the first level of accuracy, said digital terrain elevation data communicatively coupled to said system processor, said system processor configured to allow a user to select at least two of said surveyed points as reference points, said system processor programmed to determine a location of said target location system and a target with respect to said digital terrain elevation data based on the selected reference points, and translate a difference between the first level of accuracy of the determined location of the target location system and the second level of accuracy of the measured position of the target locator to the referenced location of the target.

10. A target location system according to claim 9 further comprising a rangefinder, said system processor determining the location of said target location system and the target utilizing at least a range to the selected reference points from said target location system measured by said range finder.

11. A target location system according to claim 9 wherein to determine a position of the target, said target location system is configured to translate a difference between the determined location and measured position of the target locator to the determined location of the target.

12. A target location system according to claim 9 further comprising a positioning system, said system processor configured to receive a position of said target location system from said positioning system.

13. A target location system according to claim 12 further comprising an azimuth sensing system, said azimuth sensing system operable with said system processor to measure an angle of each surveyed reference point with respect to a magnetic field and a position of said target location system, said system processor programmed to determine the angle between the surveyed reference points with respect to said target location system.

14. A target location system according to claim 12 wherein said azimuth sensing system is operable with said system processor to measure an angle to the target with respect to a magnetic field.

15. A target location system according to claim 9 wherein to determine a position of the target, said system processor is configured to:
translate a difference between the determined location and measured position of the target locator to the determined location of the target; and
convert the position of the target from digital terrain elevation data coordinates to GPS coordinates.

16. A target location system according to claim 9 further comprising an elevation inclinometer, said system processor determining an elevation of the target with respect to said target location system.

17. A processor for determining a position of a target, said processor forming a portion of a target locating system and programmed to:
receive data relating to at least two surveyed reference points from a digital terrain elevation data, wherein a resolution of the digital terrain elevation data is associated with a first level of accuracy;
receive data relating to a global position of the target locating system, wherein a resolution of the data relating to a global position is associated with a second level of accuracy, and the first level of accuracy is substantially higher than the second level of accuracy;
receive data relating to an angle to the surveyed reference points and the target with respect to a magnetic field;
receive data relating to a range to the target and a range to each surveyed reference point;
determine a location of the target locating system and with respect to the digital terrain elevation data utilizing the data relating to the range and angle to each surveyed reference point; and
determine a position of the target utilizing the data relating to the range and angle to each surveyed reference point and a translation of the difference between the first level of accuracy of the determined location of the target locating system to the second level of accuracy of the received data relating to the global position of the target locating system.

18. A processor according to claim 17 wherein to determine a position of the target, said processor is programmed to translate a position of the target from digital terrain elevation data coordinates to GPS coordinates according to the translation of the location of the target locating system to the received position of the target locating system.

19. A processor according to claim 17 wherein said processor is further configured to receive data relating to an elevation of the target from an elevation inclinometer.

20. A processor according to claim 19 wherein to determine a position of the target, said processor is programmed to translate a position of the target from digital terrain elevation data coordinates to GPS coordinates according to the translation of the location of the target locating system to the received position of the target locating system and the data relating to an elevation of the target.
